(19) United States
(12) Patent Application Publication
(10) Pub. No.: US 2013/0062156 A1
(43) Pub. Date: Mar. 14, 2013

(54) RFID EMBEDDED CURRENCY

(71) Applicant: Kapoor Chandaria, Nairobi (KE)

(72) Inventor: Kapoor Chandaria, Nairobi (KE)

(73) Assignee: KITARU INNOVATIONS INC., St. James (BB)

(21) Appl. No.: 13/230,939

(22) Filed: Sep. 13, 2011

(51) Int. Cl. G07D 5/04; G06K 19/06; G07D 5/00

(52) U.S. Cl. 194/339; 194/302; 235/492

(57) ABSTRACT

A system and method for determining whether a coin or other valuable object is authentic is presented. In one configuration a method for validating a valuable object includes attaching a validation device to the valuable object. The validation device is loaded with validation information associated with the valuable object. Later, when the when the object is to be sold or transferred to another person the validation device is wirelessly read to extract the validation information associated with the valuable object. This information used to verify if the valuable object is authentic or is not authentic, based, at least in part, the validation information associated with the valuable object.

### BACKGROUND OF THE INVENTION

1. Field of Invention

The current invention relates generally to apparatus, systems and methods of monitoring currency. More particularly, the apparatus, systems and methods related to monitoring that a specific currency is genuine. Specifically, the apparatus, systems and methods provide for verifying that a specific currency is genuine using an RFID tag.

2. Description of Related Art

Collectors of rare coins often do not have the expertise to accurately grade a coin they are interested in purchasing. In these cases they need to rely on someone else to grade a coin to estimate its value. Investors wanting to invest in gold bullion such as Krugerrand coins often may not know if the coin is authentic or not. Therefore, there exists a need for a way to allow collectors and investors to quickly determine the grade and/or authenticity of coins and precious metal bullion.

In developing countries, many people do not have bank accounts for protecting their money. Instead, people in many undeveloped countries often hide their money in their home and/or often convert their money into jewelry. Additionally, people in developing countries very often do not have credit cards or any other types of bank cards that would allow them to pay for medical expenses when traveling to other foreign countries whether it is for emergency medical care while traveling in a foreign country or if it is to pay for a planned medical treatment in another country. Furthermore, many people in developing countries often do not have health insurance that is valid in other countries where modern health/medical treatments are available.

To make matters worse, many developing countries restrict their citizens from taking the equivalent of about $10,000 U.S. dollars out of their country when traveling. These restrictions are most common in countries outside of Europe, North America, Japan, Australia and other developed countries. Often, such large sums of money are not available at a local bank in a developing country even if one could obtain special permission to carry more than $10,000 U.S. Dollars. All of these restrictions of the free movement of currency prevents people in many developing countries from free access to modern medical treatment even if they are able to afford it.

To overcome these obstacles, people in developing countries will often travel with jewelry as a form of currency. However, selling jewelry to convert it to cash upon arriving in a different country is difficult. First, one needs to find a pawn broker in a foreign country. Pawn brokers often do not pay anything near the true value for jewelry or anything close to what was paid for the jewelry. Furthermore, a pawn broker will not pay for the labor cost of the jewelry which can be about 40 percent of the value of the jewelry because the pawn broker is often only interested in the value of the gold or other such precious metals or gems in the jewelry. Also, the value is further eroded by the fact that it is hard to quantify the purity and the amount of gold/silver in the jewelry. These factors and circumstances often leads to pawn brokers taking advantage of customers desperate to convert jewelry into cash. Therefore, there exists a need for a better way to transport and/or identify wealth.

### SUMMARY OF THE INVENTION

The preferred embodiment of the invention includes a method for validating a valuable object. The method includes attaching a validation device to the valuable object. In the preferred embodiment, the validation device is a radio frequency identification (RFID) tag. The validation device is loaded with validation information associated with the valuable object. Later, when the object is to be sold or transferred to another person, the validation device is wirelessly read to extract the validation information associated with the valuable object. This information is used to verify whether the valuable object is authentic or not, based, at least in part, on the validation information associated with the valuable object.

Another configuration of the preferred embodiment validates a valuable object such as a coin. The method begins by attaching a validation device such as an RFID tag to the coin. The RFID tag can be attached using resin, epoxy glue, partially embedded in the coin, encased in packaging material or attached by other methods. Next, the RFID tag is loaded with validation information associated with the coin. This information can include serial number(s), the coin's weight, photographic data and other data as understood by those of ordinary skill in the art. The RFID tag reads the memory to extract the validation information associated with the coin. The RFID tag can be prompted to read the validation information by a wireless NFC external electronic device. After obtaining the validation information from the validation device, a verification is made to determine if the coin is authentic or is not authentic based, at least in part, on the validation information associated with the coin. For example, the weight of the valuable coin can be checked, a serial number can be checked, and photographic data can be compared to a coin.

In another configuration of the preferred embodiment, the method stores at least part of the validation information in a remote database as authentication information. In general, only an authorized dealer of the valuable object (coin) will have access to the remote database. At the time of validation of the object, the authentication information is retrieved from the remote database and a verification is made to determine if the valuable object is authentic or is not authentic based, at least in part, on the validation information in the RFID tag and on the authentication information.

### BRIEF DESCRIPTION OF SEVERAL VIEWS OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates a preferred embodiment of a validation device for validating a valuable object such as a coin.

FIG. 2 illustrates another configuration the preferred embodiment of the validation device.

FIG. 3 illustrates another configuration the preferred embodiment of the validation device.

FIG. 4 illustrates an embodiment of the preferred embodiment configured as a method for determining the authenticity of a valuable object. Similar numbers refer to similar parts throughout the drawings.

### DETAILED DESCRIPTION

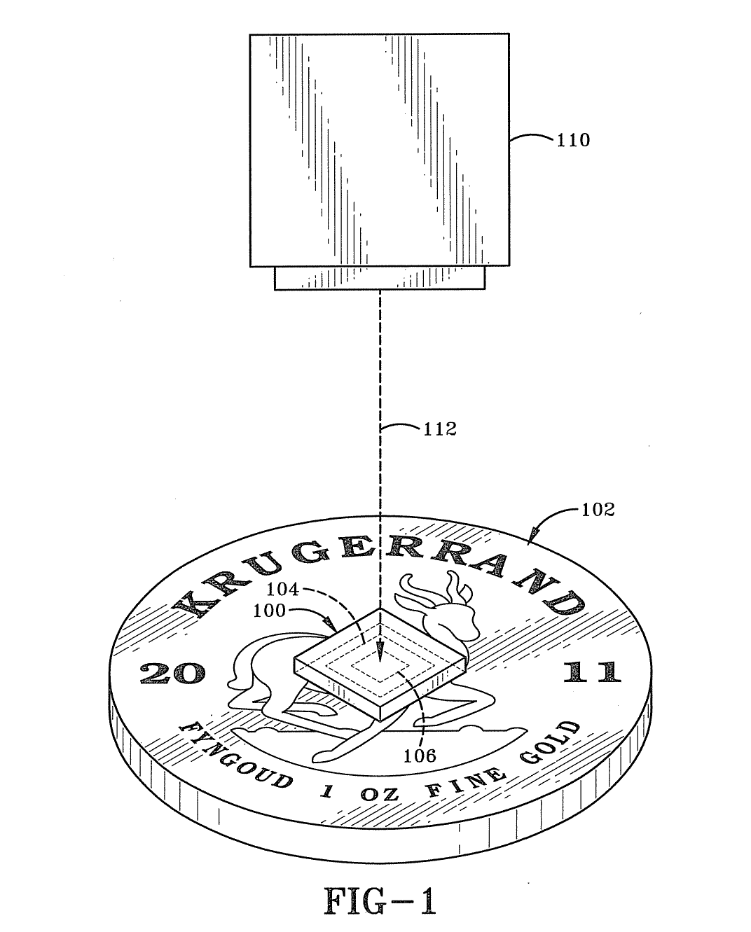

FIG. 1 illustrates the preferred embodiment of a validation device 100 for validating a valuable object such as a coin 102. FIG. 1 illustrates the validation device 100 attached to a coin 102 such as a gold Krugerrand type of coin 102. Alternatively, the validation device 100 could be attached to precious metal bullion, another type of coin, jewelry or another object. As will be discussed further below, the validation device 100 for validating a valuable object is preferably attached to a valuable object so that when it is transferred or sold to another individual the validation device 100 for validating a valuable object allows the object's authenticity to be easily determined.

The validation device 100 for validating a valuable object includes validation logic 104 and a memory 106. “Logic”, as used herein, includes but is not limited to hardware, firmware, software and/or combinations of each to perform a function(s) or an action(s), and/or to cause a function or action from another logic, method, and/or system. For example, based on a desired application or need, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

In the preferred embodiment, the memory 106 is configured to store validation data associated with the valuable object. For example, a unique serial number of the coin 102 or other valuable object the validation device 100 is attached to can be stored in the memory 106. A very accurate weight measurement of the coin 102 can be stored in the memory 106 as well as any other data that can be used to identify the coin 102 or other valuable object as the authentic original. Encryption keys can also be stored in the memory 106 that can be used to ensure that only a valid reading device 110 can request that the validation logic 104 read verification data from the memory 106.

In the preferred embodiment, the validation logic 104 can be an RFID tag. The validation logic 104 can respond to wireless signals 112 from an external device 110 and read the validation data from the memory 106. For example, the validation logic 100 can be responsive to a near field communication (NEC) signal received from an electronic device 110 such as a cellular telephone. The validation logic 104 can require a secure key be sent with a request to read the validation data from the memory 106. As will be discussed below, the external device 110 can then verify that the valuable object 102 is genuine when the read validation data matches validation data associated with the valuable object.

In the preferred embodiment, the validation device 100 for validating a valuable object 102 is configured to be securely attached to the valuable object 102 in a way that if someone tries to remove it, the validation device 100 is either damaged or destroyed to indicate it was tampered with. The validation device 100 with the validation logic 104 and memory 106 can be formed with materials that are easily broken or damaged if one were to try to bend or force the validation device 100 off of the coin 102. The validation device 100 can be secured to the valuable object 100 with an epoxy glue or other adhesive.

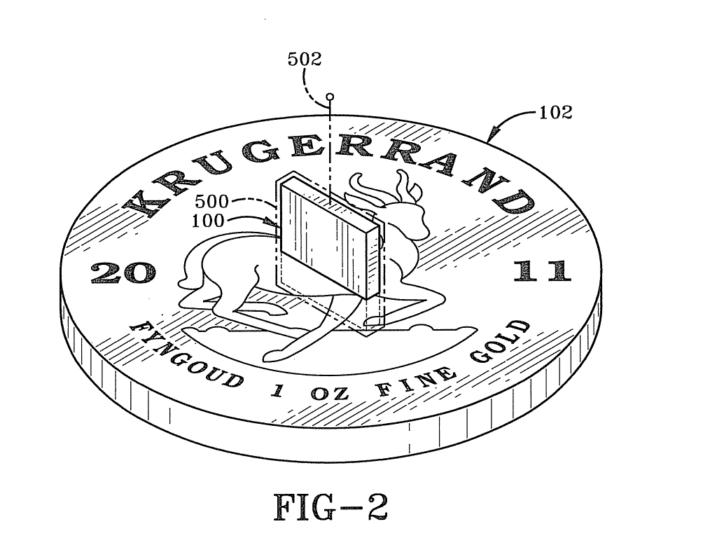

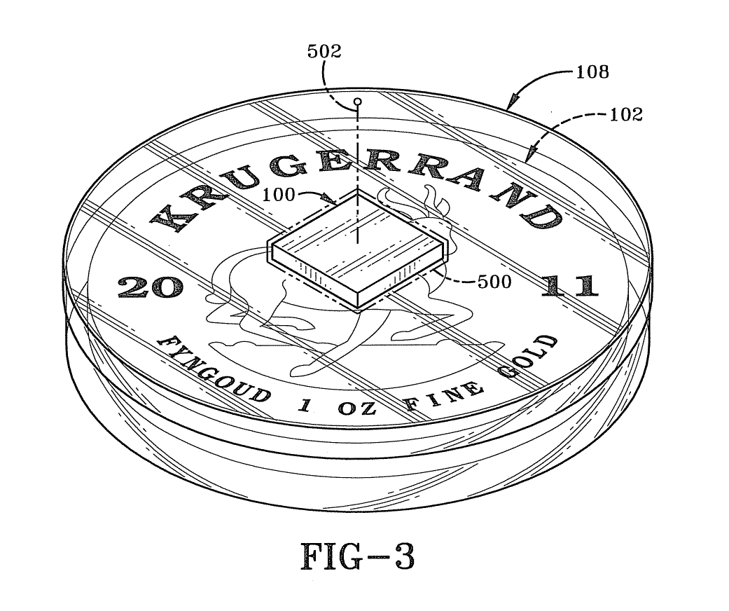

In another configuration of the preferred embodiment, the validation device 100 is partially embedded in the coin 102 or other valuable object (as shown in FIG. 2) so that it is broken if someone tries to remove it. In another configuration of the preferred embodiment, the validation device 100 is embedded or securely attached to container 108 as shown in FIG. 3. The coin 102 or other valuable object is then placed in the container 108. If the coin 102 is removed from the container 108 containing the validation device 100, then the coin 102 cannot easily later be verified as being authentic. Embedding the validation device 100 in a coin 102, partially in a coin 102 or in a container 108 may inadvertently create a Faraday's cage that will prevent or make the reading of the data of the validation device 100 encoded as electromagnetic signals difficult or impossible. To allow for the reading of the device 100 in these cases, the validation device is surrounded with an insulator 500 of sufficient thickness and/or a small antenna 502 that acts as a transmitter for the validation logic 104 to transmit read data onto. This allows the information in the memory 106 to be transmitted from a possible Faraday's cage. The antenna can be a partially looped wire around the perimeter of the coin 102 or the coins casing or another suitable wire as understood by those of ordinary skill in the art.

Placing the coin 102 in a container 108 allows the validation device 100 to be used with other rare coins that have historical/precious coin value in addition to their precious metal value. For example, rare twenty dollar gold coins can be placed in containers 108 with validation devices 100 so that the coin is not damaged by the validation device 100. Of course, those with ordinary skill in the art will realize there are other ways of securely attaching or associating the validation device 100 with the valuable object 102.

Having described the features and components of the validation device 100, its use and operation will now be described in more detail. When a valuable objection such as a Kugerrand coin is produced, the validation device 100 is attached to the coin 102. Next, verification data such as a serial number, the coin's precise weight and the like are written to the memory 106 through the validation logic 104. The verification data can include a cipher key and an encryption key. The validation logic 14 can use the encryption key in combination with the cipher key to encrypt the validation data by any encryptions algorithm as understood by those of ordinary skill in the art. This information is preferably written into the memory at the time of production of the coin 102 or a time between its production and when the coin 102 goes from a secure environment to a non-secure environment.

Later, the coin 102 is purchased by a buyer. At that time, an external device 110 can be used to request that the validation logic 104 read the validation information from the memory 106. In some embodiments of the preferred embodiment, the validation logic 104 can use the cipher key stored in the memory 106 to generate a first authorized signature. Similarly, the validation logic 104 can use an external cipher key passed to it by the external device 110 to generate a second authorized signature. The validation logic 104 compares the first authorized signature to the second authorized signature and if they are the same, validation device 100 will send the verification information to the external device 110. If they are not the same then the validation logic 104 will not send the validation information to the external device because it is not an authorized user of this information. This verification of signatures guarantees only a genuine dealer of this type of valuable product is allowed to read the verification data from the memory 106. Authorized personnel and the purchaser can use the verification data to authenticate the coin 102 as being authentic. For example, the verification data can include a very precise weight of the coin 102 and the coin 102 can be weight measured to determine if it is the same as the stored weight value. Additionally, a serial number can be checked, photographic data can be compared to a valuable object 102 and other data can be analyzed as understood by those with ordinary skill in the art.

In another configuration of the preferred embodiment, the external reader 110 will first read external verification data stored remotely from the valuable object 102. For example, the external device 110 can go to a secure database on the Internet (e.g., network cloud) and retrieve external verification data associated with the coin 102. The external reader 110 will also request the validation logic 104 retrieve the verification information stored in the memory 106. Next, the external device can compare the verification information extracted from the validation device 100 and the external database to determine if the valuable object is authentic.

Example methods may be better appreciated with reference to flow diagrams. While for purposes of simplicity of explanation, the illustrated methodologies are shown and described as a series of blocks. It is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

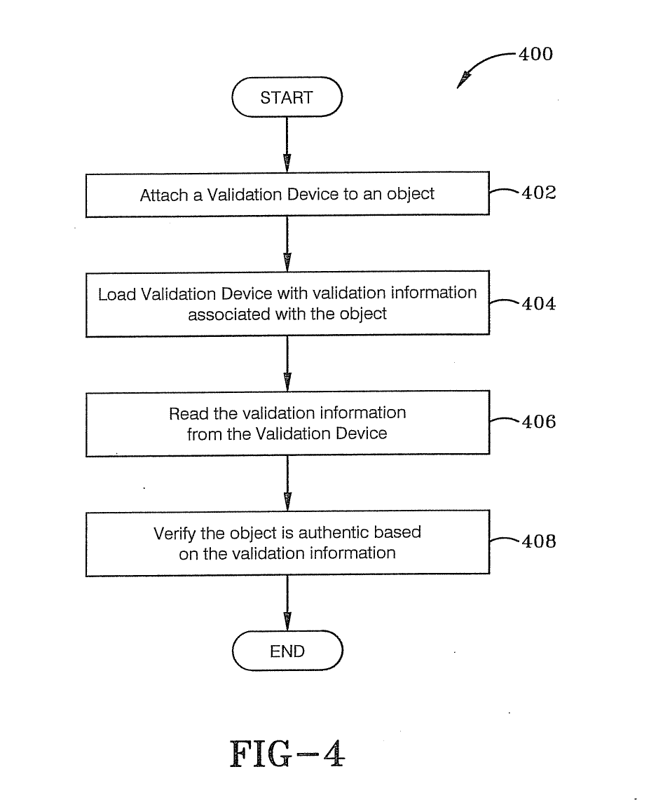

FIG. 4 illustrates a method 400 of validating a valuable object such as a coin. The method 400 begins by attaching a validation device such as an RFID tag to the valuable object, at 402. Next the validation device is loaded, at 404, with validation information associated with the valuable object. As discussed earlier, this can include serial number(s), the object's weight, photographic data and other data as understood by those of ordinary skill in the art. The validation device reads the memory, at 406, to extract the validation information associated with the valuable object. The validation device can be prompted for by a wireless NFC external electronic device. After obtaining the validation information from the validation device, a verification is made to determine if the valuable object is authentic or is not authentic, at 408, based, at least in part, on the validation information associated with the valuable object. For example, the weight of the valuable object can be checked, a serial number can be checked, photographic data can be compared to a valuable object and other data can be analyzed as understood by those with ordinary skill in the art.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the preferred embodiment” does not necessarily refer to the same embodiment, though it may.

1. A method for validating a valuable object comprising:
attaching a validation device to the valuable object after the valuable object has been manufactured and so that the validation device can later be removed from the valuable object without damaging the valuable object;
loading the validation device with validation information associated with the valuable object;
wirelessly reading the validation device with a reading device to extract the validation information associated with the valuable object; and
based, at least in part, the validation information associated with the valuable object, verifying with a verification logic if the valuable object is authentic or the valuable object is not authentic.

2. The method for validating a valuable object of claim 1 wherein the validation device is a radio frequency identification (RFID) chip and the loading further comprises:
loading the RFID chip with the validation information.

3. The method for validating a valuable object of claim 1 wherein the valuable object is at least one of the group of: a precious coin or a piece of bullion.

4. A method for validating a valuable object comprising:
weighing the valuable object to determine its actual weight;
attaching a validation device to the valuable object;
loading the validation device with the actual weight of the valuable object;
wirelessly reading the validation device with a reading device to extract the actual weight associated with the valuable object; and
based, at least in part, the actual weight verifying with a verification logic if the valuable object is authentic or the valuable object is not authentic.

5. The method for validating a valuable object of claim 1 further comprising:
storing at least part of the validation information in a remote database as authentication information; and
retrieving the authentication information from the remote database, wherein the verifying if the valuable object is authentic or the valuable object is not authentic is based, at least in part, on the authentication information.

6. The method for validating a valuable object of claim 1 wherein the verifying if the valuable object is authentic or is not authentic is based, at least in part, on at least one characteristic of the valuable object.

7. The method for validating a valuable object of claim 1 wherein the validation device is an RFID chip and the wirelessly reading the validation device further comprises:
reading the RFID chip with a near field communication (NFC) electronic device.

8. The method for validating a valuable object of claim 1 wherein the wirelessly reading the validation device further comprises:
reading the RFID using a cellular telephone application.

9. (canceled)

10. The method for validating a valuable object of claim 1 wherein the valuable object is one of the group of: a coin and precious metal bullion.

11. The method for validating a valuable object of claim 1 wherein the attaching the validation device further comprises:
encasing the valuable object inside secure packaging, wherein the validation device is attached to the secure packing.

12. The method for validating a valuable object of claim 1 wherein the validation device is an RFID tag.

13. The method for validating a valuable object of claim 1 further comprising:
storing at least part of the validation information a network away from the valuable object; as authentication information; and
retrieving the authentication information from the network, wherein the verifying if the valuable object is authentic or the valuable object is not authentic is based, at least in part, on the authentication information.

14. The method for validating a valuable object of claim 1 further comprising:
determining the validation device has been tampered with; and wherein the verifying if the valuable object is authentic or the valuable object is not authentic is based, at least in part on determining that the validation device has been tampered with.

15. A validation device for validating a valuable object that is configured to be securely attached to the valuable object comprising:
a memory;
a validation logic configured to write validation data associated with the valuable object into the memory and read the validation data from the memory, wherein the validation logic is configured to respond to wireless signals from an external device that request a reading of the validation data from the memory, and wherein the external device verifies that the valuable object is genuine when the read validation data matches validation data associated with the valuable object, and
wherein the validation device is configured to be attached to the valuable object after the valuable object is produced, and wherein the validation device is configured to be removed from the valuable object without at least partially damaging the valuable object.

16. The validation device for validating the valuable object of claim 15 wherein the validation logic and memory is a radio frequency identification (RFID) chip.

17. The validation device for validating the valuable object of claim 15 wherein the validation logic is configured to be attached to the valuable object in a way that will indicate that the validation logic was tampered with or the validation logic will be destroyed if the validation logic is tampered with.

18. The validation device for validating the valuable object of claim 15 wherein the valuable object is one of the group of: a coin and precious metal bullion.

19. The validation device for validating the valuable object of claim 15 wherein the validation data includes a weight of the valuable object.

20. The validation device for validating the valuable object of claim 15 wherein the external device is configured to read external verification data that is stored remotely from the valuable object and not in the memory in the validation device, and wherein external authentication logic is configured to verify that the valuable object is authentic, based at least in part on the external verification data and the validation data in the memory.
